(19) United States
(12) Patent Application Publication
(10) Pub. No.: US 2026/0169818 A1
(43) Pub. Date: Jun. 18, 2026

(54) APPARATUS AND METHOD FOR PERFORMING AN ATTENTION OPERATION ON A HETEROGENEOUS PROCESSOR PLATFORM

(71) Applicant: Intel Corporation, Santa Clara, CA (US)

(72) Inventors: Aditya Chatterjee, West Bengal (IN); Kareem Mohiddeen Shaik, Bangalore (IN)

(73) Assignee: Intel Corporation, Santa Clara, CA (US)

(21) Appl. No.: 19/536,015

(22) Filed: Feb. 10, 2026

(51) Int. Cl. G06F 9/50; G06F 9/48

(52) U.S. Cl. CPC G06F 9/505; G06F 9/4881; G06F 9/5066

(57) ABSTRACT

Apparatus and method for processing attention operations. For example, a plurality of queues are allocated in memory, the plurality of queues corresponding to a plurality of heterogeneous processor types; a first set of nodes of an attention graph are submitted which have data dependencies resolved in accordance with a dependency tracking data structure, to the plurality of queues; the first set of nodes are dispatched for execution from the selected queues, starting with a node corresponding to a processor of one of the heterogeneous processor types which is associated with a relatively longer execution time than other nodes executed on other heterogeneous processor types; updating the dependency tracking data structure to reflect corresponding newly-resolved data dependencies; and submitting a second set of nodes of the attention graph associated with the corresponding newly-resolved dependencies in accordance with the dependency tracking data structure, to the plurality of queues.

### BACKGROUND

### Field of the Invention

This invention relates generally to the field of processors. More particularly, the invention relates to an apparatus and method for performing an attention operation on a heterogeneous processor platform.

### Description of the Related Art

Attention operations are the most compute-intensive and memory bound operations in Transformer architectures. As the number of variants of the attention operation have exploded, optimized implementations like FlashAttention have been introduced for some attention variants. FlashAttention is an algorithm that efficiently executes attention operations on a graphics processor, performing matrix multiplications in blocks such that each block fits within the graphics processor cache. By careful management of the blocks, FlashAttention minimizes data copying between the graphics processor caches, which would reduce performance.

However, these optimization implementations only support a small number of transformer variants, leaving the majority of attention variants unoptimized.

### BRIEF DESCRIPTION OF THE DRAWINGS

A better understanding of the present invention can be obtained from the following detailed description in conjunction with the following drawings, in which:

FIG. 1 illustrates an example architecture on which embodiments of this disclosure may be implemented.

FIG. 2 illustrates principles associated with query matrix, a key matrix, and a corresponding value matrix.

FIG. 3 illustrates a method in accordance with embodiments of this disclosure.

FIG. 4 illustrates an example graph arranged in two slices for processing data elements of the Q (query) matrix, the K (key) and V (value) matrices (or portions thereof), and the S (Softmax) matrix.

FIG. 5 illustrates another example of a directed acyclic graph (DAG) executed by a combination of MME and TPC operations.

FIG. 6 illustrates the DAG with the Heterogeneous Earliest Finish Time (HEFT) rank indicated for each node.

FIG. 7 illustrates scheduling logic in accordance with some embodiments of this disclosure.

FIG. 8 illustrates a method in accordance with some embodiments of this disclosure.

FIG. 9 illustrates a processor architecture in accordance with some embodiments of this disclosure.

### DETAILED DESCRIPTION

Embodiments of this disclosure include mechanisms to efficiently schedule attention operations associated with a transformer architecture (e.g., a large language model (LLM)) across heterogeneous processors. Attention operations identify portions of the input which are the most important when processing a specific piece of information. The scaled dot-product attention mechanism allows every element in a sequence (like a word in a sentence) to look at every other element and calculate a “relevance score,” indicating the level of focus to place on them.

In accordance with the embodiments of this disclosure, attention operations are scheduled across available heterogenous processors in accordance with the traversal of a computational attention graph. In some embodiments, a different work queue is allocated to store operations for each processor type, from which multiple processors of that processor type may process work items. For example, in an implementation with two different types of heterogeneous processors, two queues are allocated to store attention operations for each respective processor type. Embodiments of this disclosure implement techniques to alleviate data conflicts among scheduled attention operations, and schedule certain operations to specific heterogeneous processors based on the processor capabilities.

Additionally, some embodiments implement techniques to track potential data conflicts among attention operations to be scheduled and to track the status of each heterogeneous processor prior to making scheduling decisions.

Some embodiments also prioritize scheduling to heterogeneous processor types in ascending order of throughput performance (slowest to fastest) to improve overall performance.

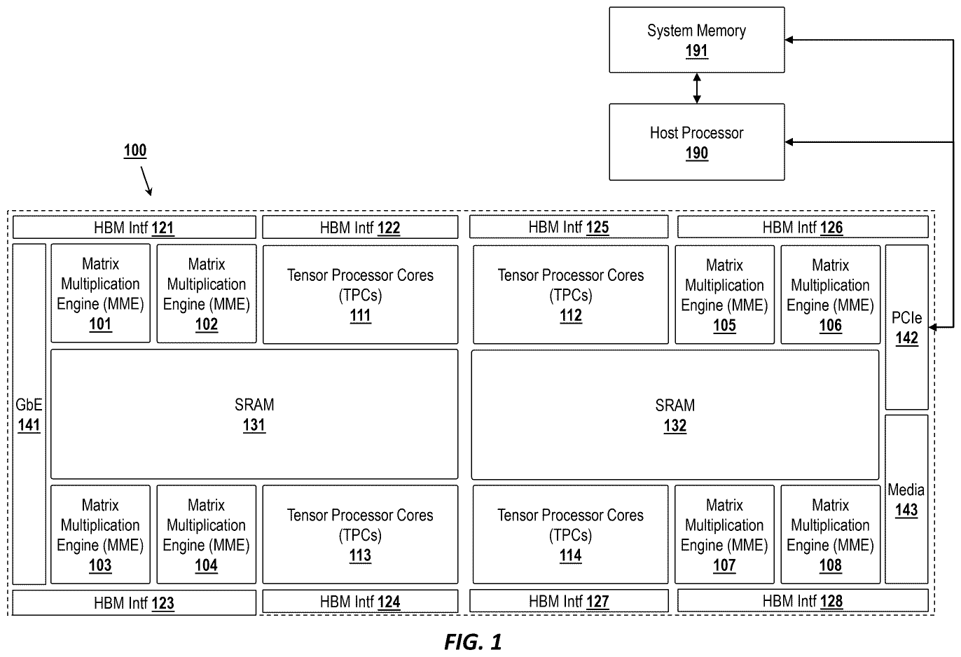

Byway of an overview, FIG. 1 illustrates an example accelerator device 100 comprising heterogeneous processors: a plurality of matrix multiplication engines (MMEs) 101-108 and a plurality of tensor processor cores (TPCs) 111-114. The MMEs 101-108 are responsible for executing operations which can be reduced to matrix multiplications (e.g., fully connected layers, convolutions, batched-GEMM, etc.) while the TPCs 111-114 are very large instruction word (VLIW) single-instruction multiple-data (SIMD) processors configured specifically for deep learning operations. For example, the TPCs 111-114 operate in accordance with an instruction set and hardware tailored to serve training workloads efficiently. The TPCs are programmable and provide various workload-oriented features, such as non-GEMM operation acceleration, tensor addressing, latency hiding capabilities, and random number generation.

The MMEs 101-108 and TPCs 111-114 are coupled to High Bandwidth Memory (HBM) devices via high speed HBM interfaces 121-128. In various embodiments described herein, the queues associated with each processor type are allocated in the HBM or in a system memory 191 to store the attention operations associated with an attention graph. The accelerator device may also include dedicated scheduling hardware and software (not shown) for submitting the attention operations to the device-type queues.

The accelerator is coupled to a host processor 190 and system memory 191 via one or more PCIe interfaces 142 and/or gigabit Ethernet interfaces 141. For example, in some embodiments, the host processor 190 executes a scheduler (e.g., implemented in firmware or software) which submits attention operations to the device-type queues in system memory 191 or HBM. The illustrated embodiment also includes media logic 143 for performing various forms of multimedia encode/decode operations as described herein.

While TPCs 111-114 and MMEs 101-108 are used as examples of heterogeneous processors, the underlying principles of this disclosure may be implemented on different architectures having alternate sets of heterogeneous processors, such as central processing units (CPUs), graphics processors (GPUs), neural processing units (NPUs), and digital signal processors (DSPs).

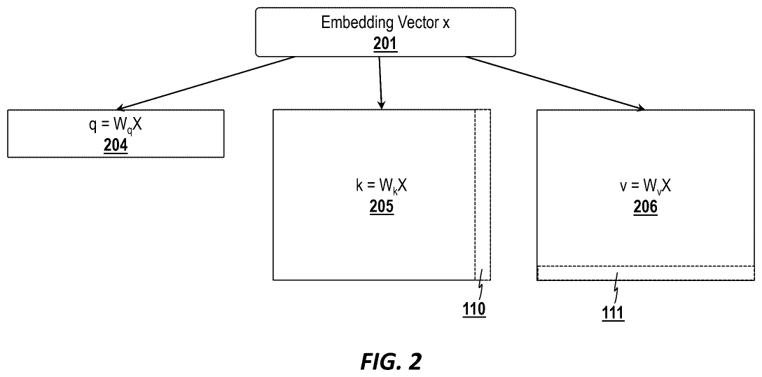

Modern LLMs rely heavily on autoregressive token generation, where each new token depends on the full context of previously generated tokens. To maintain this context efficiently, a key/value (KV) cache stores the attention keys and values from earlier decoding steps to avoid redundant computation. Referring to FIG. 2, at the transformer layer, each token corresponds to an embedding vector x 201 (e.g., generated based on the token), which is multiplied by a query matrix W_{q}, a key matrix Wₖ, and a value matrix Wᵥ to generate a new query vector 204, new key matrix 205, and new value matrix 206, respectively. For example, a static input with a fixed input length is fed into the transformer layer and split into tokens using a tokenization scheme such as Byte Pair Encoding. Each token ID is mapped to a row in an embedding vector before being multiplied by the query matrix W_{q}, key matrix Wₖ, and value matrix Wᵥ. The query vector 204 represents the new token in this decoder operation. The key matrix, Wₖ, represents all the previous context that the model should be aware of, and the value matrix, Wᵥ, also represents the previous context which is applied after the softmax operation as a weighted sum during the attention mechanism.

When the key and value matrices are cached in memory, the embedding vector 201 multiplication only generates one new column 210 in the new key matrix 205 and one new row 211 in the value matrix 206. A dot product is then performed between the new query vector 204 and the new key matrix 205 and a softmax operation is performed and applied as a weighted sum over the new value matrix 206 to generate scaled dot product attention values. In auto-regressive decoding, one word at a time is processed based on all of the previous context. The K and V matrices 205-206 contain information about the entire word sequence but the query vector 204 only contains information about the last token (i.e., word, sub-word, punctuation, space, etc.) that has been seen. The dot product between the query vector 204 and the key matrix 205 can be thought of as an attention calculation between the current token and all of the previous tokens at the same time. Because the sequence is generated one token at a time, the K and V matrices do not change significantly with each new token and can be cached in memory so that all of the prior context data does not need to be recalculated with each new token (which would result in extremely low performance).

Given the above overview, embodiments of this disclosure attempt to optimally schedule attention operations across heterogeneous processors to ensure maximum pipelining and efficiency. Additionally, given a specific heterogeneous processing architecture, some embodiments of this disclosure are operable to determine an optimal graph recipe structure for attention operations.

In particular, to distribute and pipeline an attention workload specified by a computational attention graph across the heterogeneous processors, each operation is represented as a node in the graph and relationships between operations are defined by edges of the graph. In the described embodiments, the computation attention graph is a directed acyclic graph (DAG) where connections between nodes have a specific direction. At a given node of the graph, each edge input from another node (in-degree) indicates an incoming dependency which is tracked to determine when the corresponding operation is ready to execute. Note that the terms “attention graph,” “computational attention graph,” and “graph” are used interchangeably herein.

In some implementations, each operation and corresponding graph node is assigned a label indicating the type of processor on which the operation will be executed. For example, when executed on the architecture in FIG. 1, a given node may have a label identifying either the TPCs or MMEs onto which the corresponding operation will be executed.

Thus, an attention operation corresponding to a node of the graph is scheduled for execution when all incoming dependencies have been resolved (e.g., when the nodes generating the incoming edges have been executed, i.e., in-degree=0) and is dispatched to the execution circuitry when a corresponding processor type becomes available.

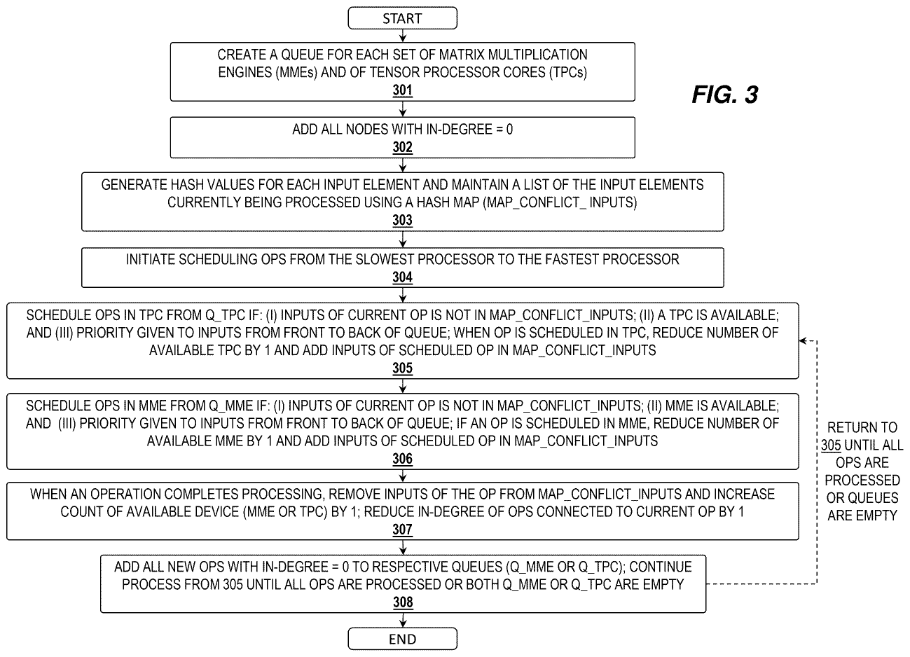

FIG. 3 illustrates a method in accordance with some embodiments in which the heterogeneous processors include the MMEs and TPCs.

At 301, a queue is created for each heterogeneous component which maintains a plurality of entries corresponding to a plurality of attention operations to be executed. For example, a first queue (Q_MME) may be created to store operations for execution by the set of MMEs 101-108 and a second queue (Q_TPC) may be created to store operations for execution by the TPCs 111-114. In other embodiments, separate queues may be established for each individual MME and TPC.

At 302 one or more candidate nodes for which incoming dependencies are resolved may be added to the queues. This condition is sometimes referred to herein as nodes with in-degree=0. The “in-degree” of an operation represents the number of incoming edges from other nodes, which effectively counts the number of dependencies (prior operations) that must completed before this operation can start. When an operation has an in-degree=0, it has no unmet dependencies. As used herein, the dependencies indicated by an attention graph structure can include data dependencies, in which a child node in the graph must wait for data to be produced by a parent node before executing.

At 303, hash values are generated for each input element and a list of the input elements currently being processed is maintained using a hash map or a hash set within a tracking data structure referred to herein as MAP_CONFLICT_INPUTS. In these embodiments, the hash map or hash set may be internally implemented using a data structure such as a binary tree or a dynamic array.

At 304, to hide scheduling latency, attention operations are first scheduled and dispatched to the slowest or lowest performance processor or processor type, if the architecture provides this differentiation. After scheduling is performed for the slowest processor type, scheduling is then performed for the faster or higher performance processors. In these embodiments, for example, a first type of processor, such as the TPC, may be identified as the “slower” processor type given that the workloads executed by the first processor type tend to require more processor cycles than the “faster” processor type, such as the MME.

At 305, attention operations are first scheduled for execution by a TPC from the Q_TPC if: (i) the inputs for the current operation are resolved and valid (e.g., not stored in the MAP_CONFLICT_INPUTS data structure); (ii) a TPC is available; and (iii) priority is given to inputs from the front to the back of the Q_TPC. When an attention operation is scheduled on the TPC, the number of available TPCs is reduced by 1 in an operation tracking structure and inputs of the scheduled operation are added in MAP_CONFLICT_INPUTS.

At 306, attention operations are then scheduled for execution by an MME from the Q_MME if: (i) the inputs of current operation are valid (e.g., not stored in the MAP_CONFLICT_INPUTS data structure); (ii) an MME is available; and (iii) priority is given to inputs from the front to the back of the Q_MME. If an attention operation is scheduled on an MME, the number of available MMEs is reduced by 1 in the operation tracking structure and inputs of the scheduled operation are added in MAP_CONFLICT_INPUTS.

At 307, when an attention operation completes processing, its inputs are removed from the MAP_CONFLICT_INPUTS and the count of relevant devices (MME or TPC) is modified (e.g., incremented by 1). In addition, the in-degree value of operations (nodes of the graph) connected to the current operation are reduced by 1 (e.g., as a result of the edge input associated with the completed operation being resolved).

At 308, all new attention operations with in-degree=0 are added to respective queues (Q_MME or Q_TPC) and the process continues from 305 until all attention operations are processed or both Q_MME or Q_TPC are empty.

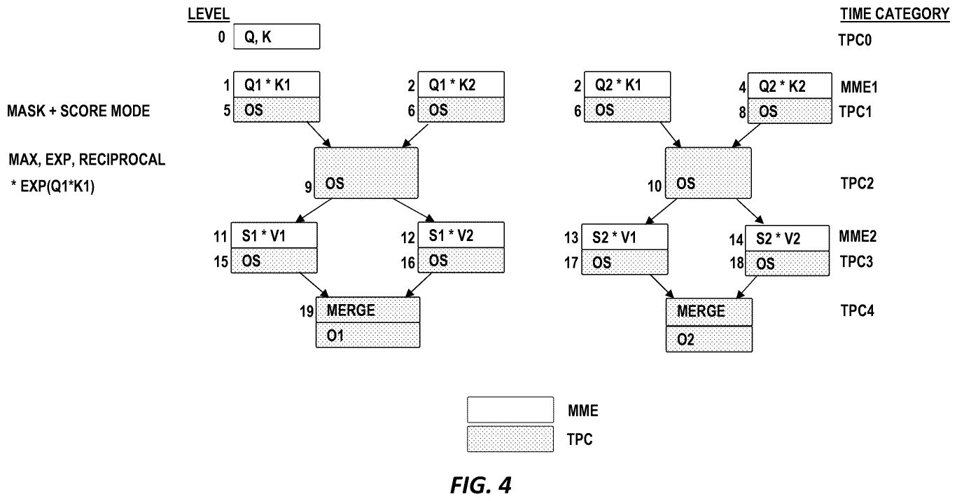

Some specific examples are provided below with reference to the DAGs in FIGS. 4-6 for the purpose of explanation. It should be noted, however, that the underlying principles of this disclosure are not limited to these specific details.

FIG. 4 illustrates an example graph in which data elements of the Q (query) matrix, the K (key) and V (value) matrices (or portions thereof), and the S (Softmax) matrix are loaded across two slices. The illustrated directed acyclic graph (DAG) represents the computation recipe for an attention operation in which the workload is split between a plurality of MMEs (unshaded nodes) and a plurality of TPCs (shaded nodes). Two disjoint slices of query data, Q1 and Q2, are processed in the left and right branches, respectively, i.e., Q1*K1, Q1*K2 on the left branch and Q2*K1, Q2*K2 on the right branch.

The matrix multiplication engines (MMEs), represented by unshaded nodes, perform compute-intensive matrix multiplication operations. MME1 (Level 1) performs the initial Q×K multiplications (e.g., Qn*Kn) and MME2 (Level 4) performs the subsequent S×V multiplications (e.g., Sn*Vn). In particular, S1 and S2 are elements of an Attention Score matrix (often the result of a Softmax operation on Q×K)) and V1 and V2 are elements from the Value matrix. The inputs provided from TPC2 (Level 3) include results of max, exp, and reciprocal operations required for calculating Softmax. Thus, in this example, the tensor processor cores, represented by shaded nodes, handle element-wise and non-linear operations. In particular, TPC0 (Level 0) processes the initial inputs Q, K; TPC1 (Level 2) executes Mask+Score mode operations and TPC2 (Level 3) calculates maximums, exponents, and reciprocals for Softmax (e.g., *exp(Q1*K1)); and TPC3 and TPC4 (Levels 5 & 6) handle the final processing and a “merge” operation to combine the outputs.

FIG. 4 structures these operations into 7 distinct levels or “time categories” to illustrate dependencies between nodes of the graph. The flow proceeds from top to bottom: TPC0→MME1→TPC1→TPC2→MME2→TPC3→TPC4. Table A illustrates the relative timing of the attention operations, which are scheduled from Q_MME and Q_TPC:

TABLE A

| | | Heterogeneous devices | | | | | |
|---|---|---|---|---|---|---|---|
| | | (2 MME, 24 TPC) | | | | | |
| Q_MME | Q_TPC | MME0 | MME1 | TPC0-23 | Scheduled | Done | Time |
| | OP_0 | | | | | | |
| | | OP_0 | | | OP_0 | | |
| | | | | | | OP_0 | TPC0 |
| OP_1, | | | | | | | |
| OP_2, | | | | | | | |
| OP_3, | | | | | | | |
| OP_4 | | | | | | | |
| OP_2, | | OP_1 | OP_4 | | OP_1, | | |
| OP_3 | | | | | OP_4 | | |
| | | | | | | OP_1, | MME1 |
| | | | | | | OP_4 | |
| OP_2, | OP_5, | | | | | | |
| OP_3 | OP_8 | | | | | | |
| | | OP_2 | OP_3 | OP_5, OP_8 | OP_2, | | |
| | | | | | OP_3, | | |
| | | | | | OP_5, | | |
| | | | | | OP_8 | | |
| | | OP_2 | OP_3 | OP_5, OP_8 | | | |
| | OP_6, | | | OP_5, OP_8 | | OP_2, | MME1 |
| | OP_7 | | | | | OP_3 | |
| | | | | OP_5, OP_8, | OP_6, | | |
| | | | | OP_6, OP_7 | OP_7 | | |
| | | | | OP_6, OP_7 | | OP_5, | TPC1 |
| | | | | | | OP_8 | |
| | OP_9, | | | | | OP_6, | MME1 |
| | OP_10 | | | | | OP_7 | |
| | | | | OP_9, | OP_9, | | |
| | | | | OP_10 | OP_10 | | |
| OP_11, | | | | | | OP_9, | TPC2 |
| OP_12, | | | | | | OP_10 | |
| OP_13, | | | | | | | |
| OP_14 | | | | | | | |
| OP_12, | | OP_11 | OP_14 | | OP_11, | | |
| OP_13 | | | | | OP_14 | | |
| OP_12, | OP_15, | | | | | OP_11, | MME2 |
| OP_13 | OP_18 | | | | | OP_14 | |
| | | OP_12 | OP_13 | OP_15, | OP_12, | | |
| | | | | OP_18 | OP_13, | | |
| | | | | | OP_15, | | |
| | | | | | OP_18 | | |
| | OP_16, | | | OP_15, | | OP_12, | MME2 |
| | OP_17 | | | OP_18 | | OP_13 | |
| | | | | OP_15, | OP_16, | | |
| | | | | OP_18, | OP_17 | | |
| | | | | OP_16, | | | |
| | | | | OP_17 | | | |
| | | | | OP_16, | | OP_15, | TPC3 |
| | | | | OP_17 | | OP_18 | |
| | OP_19, | | | | | OP_16, | MME2 |
| | OP_20 | | | | | OP_17 | |
| | | | | OP_19, | OP_19, | | |
| | | | | OP_20 | OP_20 | | |
| | | | | | | OP_19, | TPC4 |
| | | | | | | OP_20 | |

Thus, using the embodiments of this disclosure, the total execution time is TPC0+(3*MME1)+TPC1+TPC2+(3*MME2)+TPC3+TPC4.

Given N slices of query Q for one recipe and two slices of K (key) and V (value), the time complexity of the illustrated scheduling algorithm is O(N²). This is not an overhead as a given LLM workload will have a fixed sequence length and therefore the size of Q, K and V will be fixed. The number of slices to be used is based on the capabilities of the accelerator (e.g., the number of MMEs, TPCs, or other heterogeneous processors) and can be determined offline.

Some embodiments include an auto-tuning process for automatically determining an optimal number of slices for a given set of heterogeneous devices (e.g., a number which will allow execution to be completed in a minimum number of cycles). Given a number of slices for Q, K and V, operation scheduling is fixed and can be computed offline beforehand using the techniques described herein.

In the example described above with respect to Table A, the total optimal execution time is TPC0+(3*MME1)+TPC1+TPC2+(3*MME2)+TPC3+TPC4. In contrast, in the case of no pipelining, the execution time would be TPC0+(4*MME1)+(4*TPC1)+(2*TPC2)+(4*MME2)+(4*TPC3)+(2*TPC4). If the TPC time is 4T and the MME time is T, then the pipelined scheduling used by some embodiments of this disclosure is 2.3× times faster than the non-pipelined scheduling.

For example, Heterogeneous Earliest Finish Time (HEFT) list scheduling is a widely used standard algorithm for mapping a set of dependent tasks (a computational graph) onto different types of processors (heterogeneous systems) to minimize the total execution time. However, HEFT list scheduling and similar scheduling algorithms are unable to achieve optimal scheduling across the heterogeneous architectures described herein (e.g., with MMEs and TPCs).

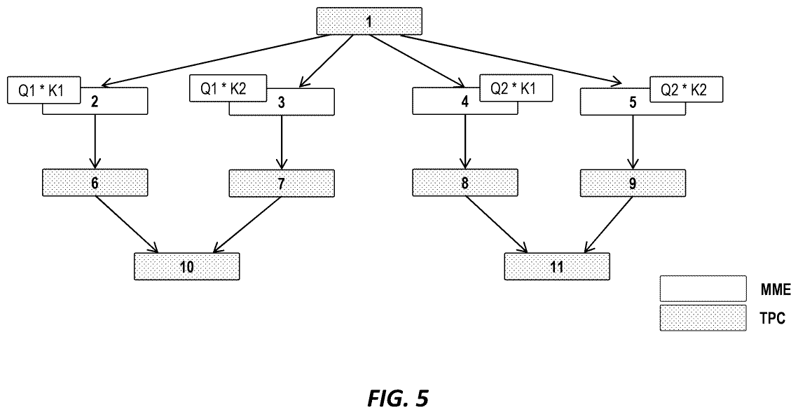

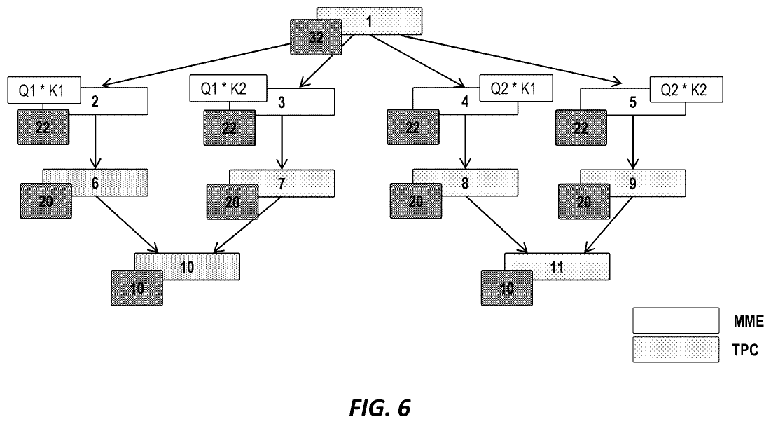

FIG. 5 illustrates a simplified DAG input to the scheduler for execution by one TPC and one MME and FIG. 6 illustrates the DAG with the HEFT rank indicated for each node (assuming the communication cost is 0 for simplicity as it will not impact the order). Nodes 2, 3, 4, and 5 take (q1, k1), (q1, k2), (q2, k1), and (q2, k2), respectively, as inputs. Nodes 6 to 11 take the output of a previous node as indicated by the edges.

If HEFT list scheduling were used to schedule the DAG, the schedule produced would be as shown in Table B. The scheduling starts at the root node (1 on the TPC) as it has the highest rank. The nodes are scheduled one-by-one based on rank as devices become available. Once node 2 is scheduled, node 3 cannot be scheduled as there is only one MME. Thus, the total execution cost is: 7*10+4*2=78 units.

TABLE B

| TPC | MME |
|---|---|
| 1 | |
| | 2 |
| | 3 |
| | 4 |
| | 5 |
| 6 | |
| 7 | |
| 8 | |
| 9 | |
| 10 | |
| 11 | |

In contrast, a schedule generated in accordance with the embodiments of this disclosure is shown in Table C. The root TPC node (node 1) is scheduled first, and entries for nodes 2, 3, 4, and 5 are inserted into the MME queue. The TPC queue is initially empty so the MME queue is processed, starting with node 2. Node 6 is then inserted into the TPC queue and is then processed on the TPC. In parallel with the TPC, nodes 3, 4 and 5 are processed sequentially on the MME. Once the execution of node 6 is complete on the TPC, nodes 7-10 are processed sequentially on the TPC.

Thus, the total execution cost for this example is 7*10+1*2=72 units, in contrast to 78 units with the HEFT list scheduling implementation, an improvement of 1.083× (8.33%).

TABLE C

| TPC | MME |
|---|---|
| 1 | |
| | 2 |
| 6 | 3 |
| | 4 |
| | 5 |
| 7 | |
| 8 | |
| 9 | |
| 10 | |
| 11 | |

As another example, assume that nodes 2, 3, 4, and 5 take (q1, k1), (q1, k2), (q2, k1), and (q2, k2) as inputs, respectively. Other nodes 6 to 11 take the output of previous node as demonstrated by edges. Nodes 6, 7, 8, and 9 take the (q1, k1) output of 2), the (q1, k2) output of 3, the (q2, k1) output of 4, and the (q2, k2) output of 5 as input, respectively.

Choosing the slowest device first in this instance helps maintain the optimal scheduling order. In this example, the HEFT/list scheduling order remains the same, with the total execution time=78 units.

The scheduling order in accordance with this embodiment is shown in Table D, where the total execution cost will be 7*10+2*2=74 units, an improvement of 1.054× (5.4%).

TABLE D

| TPC | MME |
|---|---|
| 1 | |
| | 2 |
| 6 | 5 |
| 9 | |
| | 3 |
| 7 | 4 |
| 8 | |
| 10 | |
| 11 | |

Thus, the embodiments described above show a 5.4% to 8.33% improvement with a simple graph with just one TPC and one MME device. As the number of heterogeneous devices and the graph width (the number of nodes in a given level) increases, the improvement factor increases linearly as more operations are pipelined.

Stated more generally, embodiments of this disclosure operate on a Directed Acyclic Graph (DAG) G=(V, E), with nodes V and edges E. Each node v∈V has an attribute t(v)∈(A, B), indicating the device type required for execution. There are N devices of type A and M devices of type B (e.g., where N and M can be any two integer values).

The DAG can be partitioned into (L) levels. For each level l (where 1=1, 2, . . . , L), all nodes at level l have the same execution time ci. That is, ∀v,w∈level l; c(v)=c(w)=ci and c(v) is the execution time for node v.

The graph edges are directed from nodes at level (l) to nodes at levels l′ (l′>l). A node can only start execution after all its predecessors have finished (i.e., only after all other nodes connected to the node via edges have completed). At any time, no more than (N) tasks of type (A) and (M) tasks of type (B) can execute in parallel.

The embodiments described herein schedule all nodes onto the available processing resources (N type A devices and M type B devices) to minimize the total execution time for all nodes (i.e., minimizing the “makespan”), utilizing pipelined parallelism, while respecting precedence constraints (i.e., no node can start before its dependencies are resolved), device type constraints (a node must be scheduled on a processor of its required type), and device count constraints (no more than N tasks (for (A)) and M tasks (for (B)) can run in parallel at anytime).

Stated differently, implementations of this disclosure determine a schedule S, assigning each node a start time, such that:

For every edge ((u, v) in E), (S(v) >=
S(u) + c_{l(u)}) where

S(v) = start time of node v,
l(u) is the level of node (u), and
c_{l(u)} is the execution cost
of nodes at level l(u);

at any time (t), the number of nodes running
of type (A) does not exceed (N)
and of type (B) does not exceed (M);
each node Is assigned to an
appropriate device type; and
MIN(T) = MAX({v in V} S(v) +n).
c_{l(v)}) (i.e., minimize the makespa

These embodiments have an average case and worst case time complexity of: O(D*V²/L), where:
D=number of device types;
V=total number of nodes in the computational graph; and
L=number of levels in the graph.

The maximum stack size used by these embodiments is the maximum number of nodes in level l. The number of nodes in a given level will be O(V/L) in the average case for the attention computational graph. As the stack is traversed for every node placement on a device, the total time complexity is O((size of stack)*V).

The worst case and average case space complexity is O(D*V/L) based on the stack used. This is not an overhead as the scheduling order may be cached and scheduling time may be masked in subsequent iterations. For the first iteration, the impact will be negligible as the computation cost of LLM operations is significantly more than the time to determine the scheduling order from the computational graph.

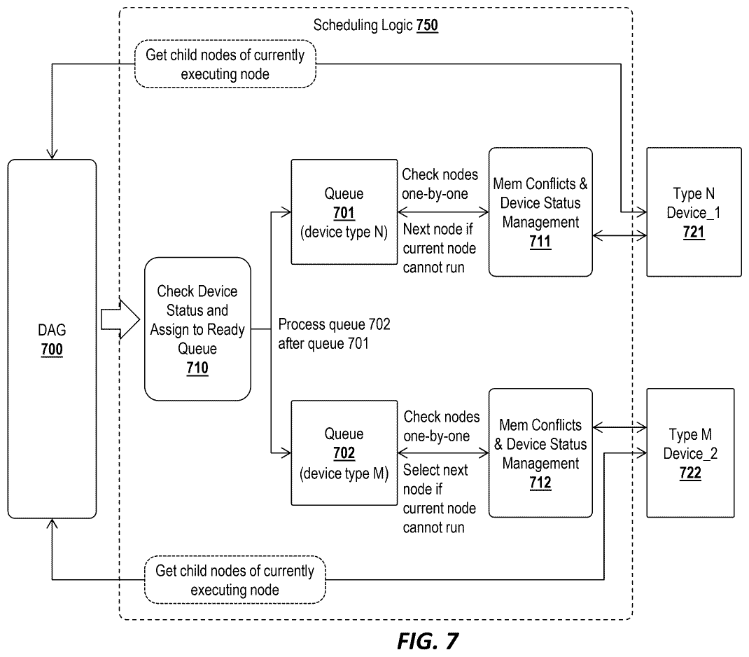

FIG. 7 illustrates scheduling logic 750 for scheduling nodes of a directed acyclic graph (DAG) 700 for execution on processing devices of a first type 721 (Type N) and processing devices of a second type 722 (Type M). As mentioned, each node of the DAG 700 corresponds to an attention operation and dependencies between nodes are indicated via directed graph edges. Separate queues, 701 and 702, are maintained for the respective device types, 721 and 722, respectively. While only a single device of each device type is illustrated for simplicity, multiple devices of each device type may process nodes from a device type queue. In some embodiments, each Type N device 721 is a TPC and each Type M device 722 is an MME, although the underlying principles of this disclosure are not limited to any particular device types.

Memory conflicts and device status management 711-712 tracks memory conflicts and the status of each processor device in one or more data structures (e.g., stored in status registers and/or memory regions). For example, each device may be associated with a field (e.g., one or more bits) in a corresponding data structure which indicate whether the device is active (e.g., currently executing a node of the graph), idle (e.g., following execution of a node), or powered off by the power management subsystem (e.g., to reduce power consumption or temperature).

Additionally, the status of each of the nodes and edges in the DAG 700 may be tracked in corresponding fields of a data structure, which may be updated to indicate nodes which have been executed and nodes which are waiting to be executed. Additionally, the status of the inputs to each node may be tracked to determine when the node is ready for execution. For example, status fields may be updated to indicate whether corresponding inputs to each node are valid, e.g., upon successful execution of corresponding parent nodes. In some implementations, when all inputs to a node are marked valid, the node is ready for execution. In some embodiments, when a node is scheduled for execution, its corresponding inputs may be marked as invalid or otherwise locked to avoid memory conflicts. Upon successful execution of the node, the corresponding inputs are marked valid or unlocked.

In some embodiments, the memory conflicts and device status management 711-712 reads and writes to the MAP_CONFLICT_INPUTS data structure, described above, as a gatekeeping mechanism to prevent data conflicts during the scheduling of operations on the TPC and MME processors. For example, before scheduling any operation from the TPC or MME queues (Q_TPC or Q_MME), the MAP_CONFLICT_INPUTS data structure is checked. Scheduling of a given operation is permitted only if its specific inputs are not currently listed in the MAP_CONFLICT_INPUTS data structure. This ensures that each operation is scheduled only when its required input data is available. If a current node cannot be executed, then the next node (e.g., another node within the same level of the DAG 700) may be selected for execution.

Once an operation successfully passes the check and is scheduled on a device (TPC or MME), the memory conflicts and device status management 711-712 adds the inputs of that operation to MAP_CONFLICT_INPUTS. This effectively reserves the inputs and prevents other operations that rely on the same data from running simultaneously. When execution of the operation is complete, the memory conflicts and device status management 711-712 removes the corresponding inputs from MAP_CONFLICT_INPUTS, thereby allowing other pending operations that require these specific inputs to pass the conflict check and proceed to execution.

As indicated in FIG. 7, as a given parent node is executed by the type N device 721 or type M device 722, the corresponding child nodes may be proactively fetched from the DAG 700 to allow the child nodes to be executed directly following the parent node.

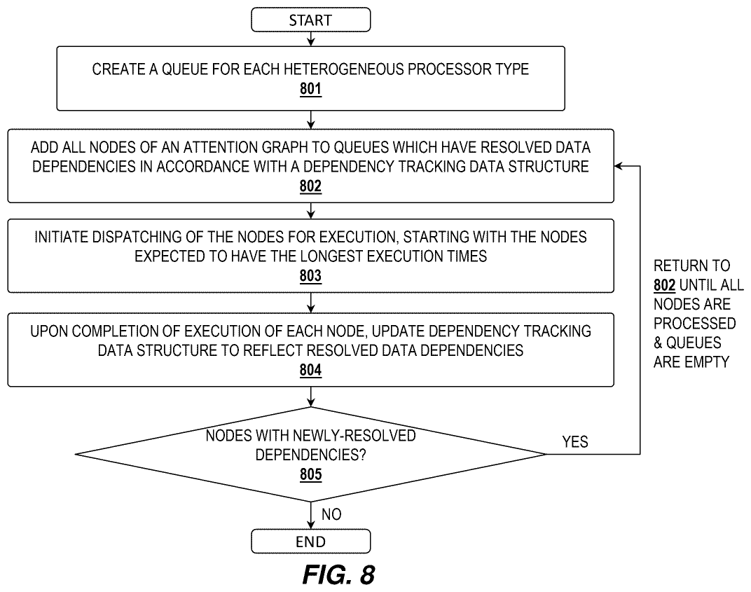

FIG. 8 illustrates a method in accordance with some embodiments of this disclosure. The method may be implemented on the architectures described herein, but is not limited to any particular processor or system architecture.

At 801, a separate queue is allocated in memory for each heterogeneous processor type. While some embodiments described herein have two processor types (TPCs and MMEs), the underlying principles of this disclosure may be implemented with any number of heterogeneous processor types.

At 802, all nodes of an attention graph which have resolved data dependencies in accordance with a dependency tracking data structure are added to the queues. For example, the dependency tracking data structure tracks the inputs to each node and indicates when nodes inputs are resolved and valid (e.g., when the corresponding parent node(s) have successfully completed).

At 803, dispatching of the nodes for execution is initiated, starting with the nodes which are expected to take the longest to execute by a respective processor. This may be done, for example, to hide the scheduling latency to the extent possible.

At 804, upon completion of the execution of each node, the dependency tracking data structure is updated to reflect newly-resolved data dependencies. For example, when the output of a parent node is an input to a child node, then when the parent node is successfully executed, the input data dependency of the child node is resolved.

Consequently, at 805, if there are any nodes with newly-resolved dependencies, the process returns to 802, where the nodes are added to corresponding queues from which they are executed. The process continues in this manner until all nodes have been processed, determined at 805.

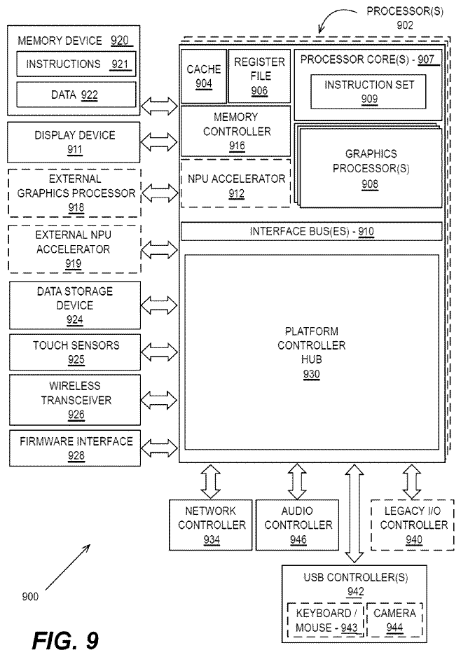

FIG. 9 is a block diagram of a processing system 900 on which embodiments described herein may be implemented. Processing system 900 may be used in a single processor desktop system, a multiprocessor workstation system, or a server system having a large number of processors 902 or processor cores 907. In one embodiment, the processing system 900 is a processing platform incorporated within a system-on-a-chip (SoC) integrated circuit for use in mobile, handheld, or embedded devices such as within Internet-of-things (IoT) devices with wired or wireless connectivity to a local or wide area network.

In some embodiments, the one or more processors 902 each include one or more processor cores 907 to process instructions which, when executed, perform operations for system or user software. In some embodiments, at least one of the one or more processor cores 907 is configured to process a specific instruction set which may facilitate Complex Instruction Set Computing (CISC), Reduced Instruction Set Computing (RISC), or computing via a Very Long Instruction Word (VLIW) instruction formats. One or more processor cores 907 may process a different instruction set 909, which may include instructions to facilitate the emulation of other instruction sets. Processor core 907 may also include other processing devices, such as a Digital Signal Processor (DSP).

In some embodiments, an NPU accelerator 912 integrated on-chip or on-package with the processors 902 processes nodes of an attention graph as described herein. In some embodiments, the NPU accelerator 912 may include a combination of heterogeneous processors (e.g., MMEs and TPCs) as described herein for accelerating attention operations. In one embodiment, an external NPU accelerator 919 (e.g., coupled to processors 902 via a high speed interconnect such as PCIe) may be used in place of or in concert with the NPU accelerator 912. An example NPU accelerator 912, 919 is illustrated in FIG. 1.

In some embodiments, the processor 902 includes cache memory 904. Depending on the architecture, the processor 902 can have a single internal cache or multiple levels of internal cache. In some embodiments, the cache memory is shared among various components of the processor 902. In some embodiments, the processor 902 also uses an external cache (e.g., a Level-3 (L3) cache or Last Level Cache (LLC)) (not shown), which may be shared among processor cores 907 using known cache coherency techniques. A register file 906 can be additionally included in processor 902 and may include different types of registers for storing different types of data (e.g., integer registers, floating point registers, status registers, and an instruction pointer register). Some registers may be general-purpose registers, while other registers may be specific to the design of the processor 902.

In some embodiments, one or more processor(s) 902 are coupled with one or more interface bus(es) 910 to transmit communication signals such as address, data, or control signals between processor 902 and other components in the processing system 900. The interface bus 910, in one embodiment, can be a processor bus, such as a version of the Direct Media Interface (DMI) bus. However, processor busses are not limited to the DMI bus, and may include one or more Peripheral Component Interconnect buses (e.g., PCI, PCI express), memory busses, or other types of interface busses. In one embodiment the processor(s) 902 include a memory controller 916 and a platform controller hub 930. The memory controller 916 facilitates communication between a memory device and other components of the processing system 900, while the platform controller hub (PCH) 930 provides connections to I/O devices via a local I/O bus.

The memory device 920 can be a dynamic random-access memory (DRAM) device, a static random-access memory (SRAM) device, flash memory device, phase-change memory device, or some other memory device having suitable performance to serve as process memory. In one embodiment the memory device 920 can operate as system memory for the processing system 900, to store data 922 and instructions 921 for use when the one or more processors 902 executes an application or process. The memory controller 916 also couples with an optional external graphics processor 918, which may communicate with the one or more graphics processors 908 in processors 902 to perform graphics and media operations.

In some embodiments a display device 911 can connect to the processor(s) 902. The display device 911 can be one or more of an internal display device, as in a mobile electronic device or a laptop device or an external display device attached via a display interface (e.g., DisplayPort, etc.). In one embodiment the display device 911 can be a head mounted display (HMD) such as a stereoscopic display device for use in virtual reality (VR) applications or augmented reality (AR) applications.

In some embodiments the platform controller hub 930 enables peripherals to connect to memory device 920 and processor 902 via a high-speed I/O bus. The I/O peripherals include, but are not limited to, an audio controller 946, a network controller 934, a firmware interface 928, a wireless transceiver 926, touch sensors 925, a data storage device 924 (e.g., non-volatile memory, volatile memory, hard disk drive, flash memory, NAND, 3D NAND, 3D XPoint, etc.). The data storage device 924 can connect via a storage interface (e.g., SATA) or via a peripheral bus, such as a Peripheral Component Interconnect bus (e.g., PCI, PCI express). The touch sensors 925 can include touch screen sensors, pressure sensors, or fingerprint sensors. The wireless transceiver 926 can be a Wi-Fi transceiver, a Bluetooth transceiver, or a mobile network transceiver such as a 3G, 4G, 5G, or Long-Term Evolution (LTE) transceiver. The firmware interface 928 enables communication with system firmware, and can be, for example, a unified extensible firmware interface (UEFI). The network controller 934 can enable a network connection to a wired network. In some embodiments, a high-performance network controller (not shown) couples with the interface bus 910. The audio controller 946, in one embodiment, is a multi-channel high-definition audio controller. In one embodiment the processing system 900 includes an optional legacy I/O controller 940 for coupling legacy (e.g., Personal System 2 (PS/2)) devices to the system. The platform controller hub 930 can also connect to one or more Universal Serial Bus (USB) controllers 942 to connect to input devices, such as keyboard and mouse 943 combinations, a camera 944, or other USB input devices.

It will be appreciated that the processing system 900 shown is exemplary and not limiting, as other types of data processing systems that are differently configured may also be used. For example, an instance of the memory controller 916 and platform controller hub 930 may be integrated into a discrete external graphics processor, such as the external graphics processor 918. In one embodiment the platform controller hub 930 and/or memory controller 916 may be external to the one or more processor(s) 902 and reside in a system chipset that is in communication with the processor(s) 902.

For example, circuit boards (“sleds”) can be used on which components such as CPUs, memory, and other components are placed, and are designed for increased thermal performance. In some examples, processing components such as the processors are located on a top side of a sled while near memory, such as DIMMs, are located on a bottom side of the sled. As a result of the enhanced airflow provided by this design, the components may operate at higher frequencies and power levels than in typical systems, thereby increasing performance. Furthermore, the sleds are configured to blindly mate with power and data communication cables in a rack, thereby enhancing their ability to be quickly removed, upgraded, reinstalled, and/or replaced. Similarly, individual components located on the sleds, such as processors, accelerators, memory, and data storage drives, are configured to be easily upgraded due to their increased spacing from each other. In the illustrative embodiment, the components additionally include hardware attestation features to prove their authenticity.

A data center can utilize a single network architecture (“fabric”) that supports multiple other network architectures including Ethernet and Omni-Path. The sleds can be coupled to switches via optical fibers, which provide higher bandwidth and lower latency than typical twisted pair cabling (e.g., Category 5, Category 5e, Category 6, etc.). Due to the high bandwidth, low latency interconnections and network architecture, the data center may, in use, pool resources, such as memory, accelerators (e.g., GPUs, graphics accelerators, FPGAs, ASICs, neural network and/or artificial intelligence accelerators, etc.), and data storage drives that are physically disaggregated, and provide them to compute resources (e.g., processors) on an as needed basis, enabling the compute resources to access the pooled resources as if they were local.

A power supply or source can provide voltage and/or current to processing system 900 or any component or system described herein. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

### EXAMPLE

The following are example implementations of different embodiments of the invention.

Example 1. A machine-readable storage medium having program code stored thereon which, when executed by a machine, is to cause the machine to perform operations, comprising: allocating a plurality of queues in a memory, the plurality of queues corresponding to a plurality of heterogeneous processor types; submit a first set of nodes of an attention graph which have data dependencies resolved in accordance with a dependency tracking data structure, to the plurality of queues; dispatching the first set of nodes for execution from the selected queues, starting with a node corresponding to a processor of one of the heterogeneous processor types which is associated with a relatively longer execution time than other nodes executed on other heterogeneous processor types; upon completing execution of one or more nodes of the first set of nodes, updating the dependency tracking data structure to reflect corresponding newly-resolved data dependencies; and submitting a second set of nodes of the attention graph associated with the corresponding newly-resolved dependencies in accordance with the dependency tracking data structure, to the plurality of queues.

Example 2. The machine-readable storage medium of Example 1, wherein the program code is to cause the machine to perform additional operations, comprising: upon completing execution of each node of the second set of nodes, updating the dependency tracking data structure to reflect second corresponding newly-resolved data dependencies; and submitting additional sets of nodes of the attention graph to the plurality of queues, including a third set of nodes associated with the second corresponding newly-resolved dependencies, until all nodes have been successfully executed.

Example 3. The machine-readable storage medium of Example 1, wherein the plurality of heterogeneous processor types include a first processor type configured to execute nodes of the attention graph using matrix multiplications and a second processor type configured to execute nodes of the attention graph without requiring matrix multiplications.

Example 4. The machine-readable storage medium of Example 3, wherein the first processor type is a matrix multiplication engine (MME) configured to multiply a first matrix by a second matrix to generate a result matrix, and the second processor type is a Very Long Instruction Word (VLIW), Single-Instruction Multiple-Data (SIMD) processor to accelerate non-matrix attention operations.

Example 5. The machine-readable storage medium of Example 1, wherein the plurality of queues comprise N queues and the corresponding plurality of heterogeneous processor types comprise N processor types, each queue of the N queues corresponding to one heterogeneous processor type of the N processor types.

Example 6. The machine-readable storage medium of Example 5, wherein the plurality of queues comprise first and second queues and the corresponding plurality of heterogeneous processor types comprise first and second processor types, and wherein M processors of the first processor type are to execute nodes from a first queue of the two queues, and K processors of a second processor type are to execute nodes from a second queue of the two queues.

Example 7. The machine-readable storage medium of Example 1, wherein the dependency tracking data structure is to indicate first inputs of a first node of the attention graph currently being processed by one of the heterogeneous processor types.

Example 8. The machine-readable storage medium of Example 7, wherein the program code is to cause the machine to perform additional operations, comprising: checking the dependency tracking data structure prior to executing the first node to confirm that the first inputs are not currently being used to process a different node; updating the dependency data structure with an indication that the first inputs are currently being used to process the first node; executing the first node using the first inputs on a processor of a corresponding heterogeneous processor type; and upon successful execution of the first node, removing the indication from the dependency data structure.

Example 9. A method, comprising: allocating a plurality of queues in a memory, the plurality of queues corresponding to a plurality of heterogeneous processor types; submit a first set of nodes of an attention graph which have data dependencies resolved in accordance with a dependency tracking data structure, to the plurality of queues; dispatching the first set of nodes for execution from the selected queues, starting with a node corresponding to a processor of one of the heterogeneous processor types which is associated with a relatively longer execution time than other nodes executed on other heterogeneous processor types; upon completing execution of one or more nodes of the first set of nodes, updating the dependency tracking data structure to reflect corresponding newly-resolved data dependencies; and submitting a second set of nodes of the attention graph associated with the corresponding newly-resolved dependencies in accordance with the dependency tracking data structure, to the plurality of queues.

Example 10. The method of Example 9, further comprising: upon completing execution of each node of the second set of nodes, updating the dependency tracking data structure to reflect second corresponding newly-resolved data dependencies; and submitting additional sets of nodes of the attention graph to the plurality of queues, including a third set of nodes associated with the second corresponding newly-resolved dependencies, until all nodes have been successfully executed.

Example 11. The method of Example 9, wherein the plurality of heterogeneous processor types include a first processor type configured to execute nodes of the attention graph using matrix multiplications and a second processor type configured to execute nodes of the attention graph without requiring matrix multiplications.

Example 12. The method of Example 11, wherein the first processor type is a matrix multiplication engine (MME) configured to multiply a first matrix by a second matrix to generate a result matrix, and the second processor type is a Very Long Instruction Word (VLIW), Single-Instruction Multiple-Data (SIMD) processor to accelerate non-matrix attention operations.

Example 13. The method of Example 9, wherein the plurality of queues comprise N queues and the corresponding plurality of heterogeneous processor types comprise N processor types, each queue of the N queues corresponding to one heterogeneous processor type of the N processor types.

Example 14. The method of Example 13, wherein the plurality of queues comprise first and second queues and the corresponding plurality of heterogeneous processor types comprise first and second processor types, and wherein M processors of the first processor type are to execute nodes from a first queue of the two queues, and K processors of a second processor type are to execute nodes from a second queue of the two queues.

Example 15. The method of Example 9, wherein the dependency tracking data structure is to indicate first inputs of a first node of the attention graph currently being processed by one of the heterogeneous processor types.

Example 16. The method of Example 15, further comprising: checking the dependency tracking data structure prior to executing the first node to confirm that the first inputs are not currently being used to process a different node; updating the dependency data structure with an indication that the first inputs are currently being used to process the first node; executing the first node using the first inputs on a processor of a corresponding heterogeneous processor type; and upon successful execution of the first node, removing the indication from the dependency data structure.

Example 17. A system, comprising: a memory subsystem to store a plurality of queues; a plurality of processors of a plurality of heterogeneous processor types corresponding to the plurality of queues; and scheduling logic to: schedule a first set of nodes of an attention graph which have data dependencies resolved in accordance with a dependency tracking data structure, to the plurality of queues; dispatch the first set of nodes for execution from the selected queues, starting with a node corresponding to a processor of one of the heterogeneous processor types which is associated with a relatively longer execution time than other nodes executed on other heterogeneous processor types; update the dependency tracking data structure to reflect corresponding newly-resolved data dependencies upon completing execution of one or more nodes of the first set of nodes; and submit a second set of nodes of the attention graph associated with the corresponding newly-resolved dependencies in accordance with the dependency tracking data structure, to the plurality of queues.

Example 18. The system of Example 17, wherein the scheduler is further to: update the dependency tracking data structure to reflect second corresponding newly-resolved data dependencies upon completing execution of each node of the second set of nodes; and submit additional sets of nodes of the attention graph to the plurality of queues, including a third set of nodes associated with the second corresponding newly-resolved dependencies, until all nodes have been successfully executed.

Example 19. The system of Example 17, wherein the plurality of heterogeneous processor types include a first processor type configured to execute nodes of the attention graph using matrix multiplications and a second processor type configured to execute nodes of the attention graph without requiring matrix multiplications.

Example 20. The system of Example 17, further comprising a host processor to execute firmware or software program code to implement the scheduling logic.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A machine-readable storage medium having program code stored thereon which, when executed by a machine, is to cause the machine to perform operations, comprising:
allocating a plurality of queues in a memory, the plurality of queues corresponding to a plurality of heterogeneous processor types;
submitting a first set of nodes of an attention graph which have data dependencies resolved in accordance with a dependency tracking data structure, to the plurality of queues;
dispatching the first set of nodes for execution from the selected queues, starting with a node corresponding to a processor of one of the heterogeneous processor types which is associated with a relatively longer execution time than other nodes executed on other heterogeneous processor types;
upon completing execution of one or more nodes of the first set of nodes, updating the dependency tracking data structure to reflect corresponding newly-resolved data dependencies; and
submitting a second set of nodes of the attention graph associated with the corresponding newly-resolved dependencies in accordance with the dependency tracking data structure, to the plurality of queues.

2. The machine-readable storage medium of claim 1, wherein the program code is to cause the machine to perform additional operations, comprising:
upon completing execution of each node of the second set of nodes, updating the dependency tracking data structure to reflect second corresponding newly-resolved data dependencies; and
submitting additional sets of nodes of the attention graph to the plurality of queues, including a third set of nodes associated with the second corresponding newly-resolved dependencies, until all nodes have been successfully executed.

3. The machine-readable storage medium of claim 1, wherein the plurality of heterogeneous processor types include a first processor type configured to execute nodes of the attention graph using matrix multiplications and a second processor type configured to execute nodes of the attention graph without requiring matrix multiplications.

4. The machine-readable storage medium of claim 3, wherein the first processor type is a matrix multiplication engine (MME) configured to multiply a first matrix by a second matrix to generate a result matrix, and the second processor type is a Very Long Instruction Word (VLIW), Single-Instruction Multiple-Data (SIMD) processor to accelerate non-matrix attention operations.

5. The machine-readable storage medium of claim 1, wherein the plurality of queues comprise N queues and the corresponding plurality of heterogeneous processor types comprise N processor types, each queue of the N queues corresponding to one heterogeneous processor type of the N processor types.

6. The machine-readable storage medium of claim 5, wherein the plurality of queues comprise first and second queues and the corresponding plurality of heterogeneous processor types comprise first and second processor types, and wherein M processors of the first processor type are to execute nodes from a first queue of the two queues, and K processors of a second processor type are to execute nodes from a second queue of the two queues.

7. The machine-readable storage medium of claim 1, wherein the dependency tracking data structure is to indicate first inputs of a first node of the attention graph currently being processed by one of the heterogeneous processor types.

8. The machine-readable storage medium of claim 7, wherein the program code is to cause the machine to perform additional operations, comprising:
checking the dependency tracking data structure prior to executing the first node to confirm that the first inputs are not currently being used to process a different node;
updating the dependency data structure with an indication that the first inputs are currently being used to process the first node;
executing the first node using the first inputs on a processor of a corresponding heterogeneous processor type; and
upon successful execution of the first node, removing the indication from the dependency data structure.

9. The machine-readable storage medium of claim 1, wherein the data dependencies comprise data used as input by the first set of nodes, the data produced by one or more parent nodes to the first set of nodes.

10. A method, comprising:
allocating a plurality of queues in a memory, the plurality of queues corresponding to a plurality of heterogeneous processor types;
submit a first set of nodes of an attention graph which have data dependencies resolved in accordance with a dependency tracking data structure, to the plurality of queues;
dispatching the first set of nodes for execution from the selected queues, starting with a node corresponding to a processor of one of the heterogeneous processor types which is associated with a relatively longer execution time than other nodes executed on other heterogeneous processor types;
upon completing execution of one or more nodes of the first set of nodes, updating the dependency tracking data structure to reflect corresponding newly-resolved data dependencies; and
submitting a second set of nodes of the attention graph associated with the corresponding newly-resolved dependencies in accordance with the dependency tracking data structure, to the plurality of queues.

11. The method of claim 10, further comprising:
upon completing execution of each node of the second set of nodes, updating the dependency tracking data structure to reflect second corresponding newly-resolved data dependencies; and
submitting additional sets of nodes of the attention graph to the plurality of queues, including a third set of nodes associated with the second corresponding newly-resolved dependencies, until all nodes have been successfully executed.

12. The method of claim 10, wherein the plurality of heterogeneous processor types include a first processor type configured to execute nodes of the attention graph using matrix multiplications and a second processor type configured to execute nodes of the attention graph without requiring matrix multiplications.

13. The method of claim 12, wherein the first processor type is a matrix multiplication engine (MME) configured to multiply a first matrix by a second matrix to generate a result matrix, and the second processor type is a Very Long Instruction Word (VLIW), Single-Instruction Multiple-Data (SIMD) processor to accelerate non-matrix attention operations.

14. The method of claim 10, wherein the plurality of queues comprise N queues and the corresponding plurality of heterogeneous processor types comprise N processor types, each queue of the N queues corresponding to one heterogeneous processor type of the N processor types.

15. The method of claim 14, wherein the plurality of queues comprise first and second queues and the corresponding plurality of heterogeneous processor types comprise first and second processor types, and wherein M processors of the first processor type are to execute nodes from a first queue of the two queues, and K processors of a second processor type are to execute nodes from a second queue of the two queues.

16. The method of claim 10, wherein the dependency tracking data structure is to indicate first inputs of a first node of the attention graph currently being processed by one of the heterogeneous processor types.

17. A system, comprising:
a memory subsystem to store a plurality of queues;
a plurality of processors of a plurality of heterogeneous processor types corresponding to the plurality of queues; and
scheduling logic to:
schedule a first set of nodes of an attention graph which have data dependencies resolved in accordance with a dependency tracking data structure, to the plurality of queues;
dispatch the first set of nodes for execution from the selected queues, starting with a node corresponding to a processor of one of the heterogeneous processor types which is associated with a relatively longer execution time than other nodes executed on other heterogeneous processor types;
update the dependency tracking data structure to reflect corresponding newly-resolved data dependencies upon completing execution of one or more nodes of the first set of nodes; and
submit a second set of nodes of the attention graph associated with the corresponding newly-resolved dependencies in accordance with the dependency tracking data structure, to the plurality of queues.

18. The system of claim 17, wherein the scheduler is further to:
update the dependency tracking data structure to reflect second corresponding newly-resolved data dependencies upon completing execution of each node of the second set of nodes; and
submit additional sets of nodes of the attention graph to the plurality of queues, including a third set of nodes associated with the second corresponding newly-resolved dependencies, until all nodes have been successfully executed.

19. The system of claim 17, wherein the plurality of heterogeneous processor types include a first processor type configured to execute nodes of the attention graph using matrix multiplications and a second processor type configured to execute nodes of the attention graph without requiring matrix multiplications.

20. The system of claim 17, further comprising a host processor to execute firmware or software program code to implement the scheduling logic.
